(19) United States
(12) Patent Application Publication
(10) Pub. No.: US 2012/0034285 A1
(43) Pub. Date: Feb. 9, 2012

(54) Mosquito Net with Dinotefuran and PBO for Killing Mosquitoes, Especially Mosquitoes with Pyrethroid Resistance

(76) Inventors: Mikkel Vestergaard Frandsen, Lausanne (CH); Michael Stanley Pedersen, Vaud (CH); Matthieu Zellweger, Geneva (CH); Sebastien Gouin, Lausanne (CH); Georgina Victoria Bingham, Lausanne (CH); Helen Victoria Pates Jamet, Lausanne (CH)

(21) Appl. No.: 13/264,430

(22) PCT Filed: Apr. 14, 2009
(86) PCT No.: PCT/DK09/50082

§ 371 Date: Oct. 14, 2011

(51) Int. Cl. A01N 43/08; A01P 7/04; A01N 25/08

(52) U.S. Cl. 424/403; 514/471

(57) ABSTRACT

Dinotefuran and PBO is used for killing mosquitoes, as PBO increases the knockdown speed of Dinotefuran.

### FIELD OF THE INVENTION

The present invention relates to insecticidal mosquito nets containing PBO in combination with an insecticide.

### BACKGROUND OF THE INVENTION

One of the methods to counteract malaria is the use of commercially available long lasting insecticidal mosquito nets for protecting humans from the bite of Anopheline mosquitoes that carry malaria. Whereas the typically applied pyrethroids have been used successfully as insecticides on such nets due to their rapid knockdown effect, there is currently a critical increased resistance to pyrethroids observed among those mosquitoes.

One type of resistance is metabolic, which is counteracted by applying piperonyl butoxide (PBO) simultaneously with a pyrethroid to the mosquito when resting on the net. The PBO works as an inhibitor of the resistance associated metabolic enzymes and increases the mortality rate of the pyrethroid resistant mosquitoes.

Another type of resistance is through a mutation at the target site of the pyrethroid, known as knockdown-resistance (kdr), which significantly slows the knockdown effect when the mosquito rests on the net and gives the mosquito the possibility to bite before paralysis (followed by death). This target site effect is related to the voltage-gated sodium channel gene as described in the article “Multiple Origins of Knockdown-resistance Mutations in the Afrotropical Mosquito Vector Anopheles gambiae.” published in 2007 by Pinto et al on the Internet under PLoS ONE 2(11): e1243. doi:10.1371/journal.pone.0001243.

In connection with knockdown-resistance against pyrethroids, addition of PBO is regarded as not solving the problem due to its effect on the metabolism, only.

Therefore, there is an ongoing search for other insecticides to be used for killing mosquitoes by insecticidal nets, especially for mosquitoes having developed knockdown-resistance against pyrethroids.

In the article by Corbel et al, “Dinotefuran: A potential Nicotinoid Insecticide Against Resistant Mosquitoes” published in J. Med. Entomol. 41(4): 712.717 (2004), Dinotefuran has been proposed as an insecticidal agent for bed nets. In this article, it was demonstrated that Dinotefuran had a lethal effect on mosquitoes of the species Anopheles gambiae, Aedes aegypti and Culex quinquefasciatus. Also for the mosquito strain VKPR (also termed VKPER) of the An. gambiae species, which has the mutation for knockdown-resistance against pyrethroids, Dinotefuran was demonstrated to have a lethal effect.

Despite a relatively high mortality rate of mosquitoes exposed to Dinotefuran, the use of Dinotefuran for bed nets, meanwhile, has the problem of a relatively slow action of Dinotefuran, which gives mosquitoes the chance to bite before dying. Thus, for the user experiencing a delayed knockdown effect of Anopheles gambiae strains with kdr mutations related to pyrethroids, the use of Dinotefuran on the bed net does not seem to induce an obvious change. In other words, the delayed mortality effect of Dinotefuran implies a decreased interest for using bed nets with Dinotefuran, because the user cannot observe an immediate effect combined with the fact that the mosquitoes, actually, can bite before dying.

The problem of the apparent delayed insecticidal efficacy has also been mentioned by the manufacturer of Dinotefuran, Mitsui Chemicals, in the U.S. Pat. No. 5,532,365 (col. 17 line 47-55), where it is proposed to “develop better insecticidal activity” by combining Dinotefuran with other active substances, for example a pyrethroid.

Resistance of mosquitoes against pyrethroids is also disclosed in Japanese patent application JP 10 139604 by Mitsui Chemicals, the manufacturer of Dinotefuran, which mentions a large number of guanidine compositions as a counter measure on mosquito nets. The low insecticidal efficacy is not expressed explicitly in this disclosure, however, it is mentioned that efficacy can advantageously be enhanced by combining the guanidine compositions with synergists and other insecticides. PBO is mentioned as one in a number of synergists and synthetic pyrethroids among a number of insecticides. However, no distinct selection among the compositions and the synergists and the additional insecticides is made. Also, the speed of knockdown is not discussed, especially not for the KDR strains of the Anophelines.

The low interest for Dinotefuran treated bednets is even more pronounced due to the fact that Dinotefuran does not have a mosquito repellent effect in contrast to pyrethroids, which is also mentioned in Japanese patent application JP 10 139604. The lack of repellence even increases the risk for mosquitoes biting a person under a bednet (if mosquitoes finds a way to get underneath/through it) as compared to bednets with pyrethroids such as Deltamethrin.

With regard to the overall advantages of Dinotefuran, especially the lethal effect when exposing mosquitoes of the VKPR strain of An. gambiae, which is pyrethroid resistant with the kdr mutation, there is still a solution missing to increase the speed of the knockdown effect of Dinotefuran.

### OBJECT OF THE INVENTION

Therefore, it is the object of the invention to provide a method for increasing the speed of mortality by Dinotefuran on mosquitoes, especially mosquitoes resistant to pyrethroids. It is a further object to provide a substrate, especially a mosquito net, with Dinotefuran, the substrate having a knockdown effect faster than a substrate only with Dinotefuran, especially with regard to the pyrethroid resistant mosquito strains like VKPR.

### DESCRIPTION OF THE INVENTION

This object is achieved with a method, comprising
providing a substrate made of polymer with Dinotefuran and a further active ingredient on the surface,
providing a mosquito on the substrate for uptake of the Dinotefuran, the Dinotefuran having a knockdown speed on the mosquito,
increasing the knockdown speed by Dinotefuran, the increase being due to uptake of the further active ingredient by the mosquito, preferably, the further active ingredient being PBO.

The solution for the object is a combination of Dinotefuran and an accelerator, preferably PBO, on the substrate, for example on the fibres of a mosquito net. In view of the object of the invention, this solution is surprising, especially for PBO, because PBO is not believed to increase the speed of knockdown on the mosquitoes when exposed to Dinotefuran. However, closer study has revealed that the uptake speed of the Dinotefuran by mosquitoes is increased by PBO and a quicker knockdown is obtained. Thus, by combining Dinotefuran and PBO on the substrate, the shortcomings of Dinotefuran are overcome with respect to the knockdown speed.

Though the invention is primarily explained in the following with respect to PBO, there are already indications that other substances, for example in the field of guanidines, have a likewise surprising effect—however, these preliminary results has yet to be verified experimentally for a variety of other potential accelerators.

The substrate is preferably a mosquito net or a tarpaulin. The polymer is preferably a thermoplastic polymer, for example a polyolefin or polyester (polyethylene teraphthalate).

With reference to the article of Kiriyama and Nishimura “Structural effects of dinotefuran and analogues in insecticidal and neural activities” published in Pestic. Manage. Sci. 58: 669-676 (2002), Corbel et al., reports in the above mentioned article that Dinotefuran had an increased toxicity on cockroaches when PBO was added as an oxidase inhibitor. In the Kiriyama experiment, Dinotefuran was injected into the stomach of the cockroaches in a dose that was multiple times normal lethal dosages and which causes death within minutes. With regard to the fact that PBO is not expected to have pronounced effect on pyrethroid resistant mosquito strains with the kdr mutation, the use of PBO in combination with Dinotefuran for increasing the knockdown effect specifically is not obvious in this light, because the results from the stomach injection of Dinotefuran in cockroaches leave no information about the behaviour of Dinotefuran and PBO on mosquitoes landing on mosquito nets, wall linings, or tarpaulins, where not only the uptake is of a different nature but also the insect and the conditions.

Preferably, the substrate comprises a thermoplastic polymer. Such polymer can be freely formed into desired shapes, for example sheets or fibres. Optionally, the thermoplastic polymer matrix may then be used as a carrier material for coatings.

In one embodiment, Dinotefuran and PBO are incorporated into the thermoplastic material of the polymer and distributed throughout the polymer, and the thermoplastic polymer is arranged for migration of the Dinotefuran and the PBO from its distribution inside the polymer material to the surface of the substrate.

In asecond embodiment, Dinotefuran is incorporated into the thermoplastic polymer and distributed throughout the polymer, and the thermoplastic polymer is arranged for migration of the incorporated Dinotefuran. PBO is provided in a coating on the thermoplastic polymer, the coating being arranged for migration of the Dinotefuran and the PBO through the coating to the surface of the coating.

In a third embodiment, PBO is incorporated into the thermoplastic polymer and distributed throughout the polymer, and the thermoplastic polymer is arranged for migration of the incorporated PBO. Dinotefuran is provided in a coating on the thermoplastic polymer, the coating being arranged for migration of the Dinotefuran and the PBO through the coating to the surface of the coating.

In a fourth embodiment, Dinotefuran and PBO are provided in a coating arranged for migration of Dinotefuran and PBO to the surface of the coating.

If the Dinotefuran or the PBO or both are incorporated into the fibre material of a mosquito net, it is arranged such that these active ingredients migrate through the material from its distribution in the fibre material to the surface of the fibre. If the fibres are also coated in an impregnation process, it is made sure that the active components Dinotefuran and PBO can migrate through this coating material in order to reach the surface of the fibre.

In a fifth embodiment, PBO or Dinotefuran or both are provided in a coating of a thermoplastic polymer material. This coating serves as a reservoir of the contained active ingredient. This coating is covered by a further coating, which serves as a protection against wash off and mechanical abrasion. For example, this further coating may contain fluorocarbons for protection against oil and water or other detergents.

In the above embodiments and below, PBO may be substituted by another active ingredient increasing the speed of the knockdown effect of Dinotefuran. At present, PBO seems to be the most efficient, however, there are indications that other accelerators may be used as well, for example of the type of guadinines.

Incorporation of Dinotefuran or PBO or both into substrate material, for example mosquito net fibres, can be achieved by blending the active ingredient with the polymer material prior to extrusion of the blend. In this connection, it is made sure, that the extrusion temperature of the material is not exceeding the temperature at which the active ingredient is deteriorating to large degree. For example, the temperature may be chosen not higher than a level, where at most 1% or 10% or 30% or 50% or 90% of the Dinotefuran or PBO or both deteriorate in the extrusion process before the extruded material is cooled.

Appropriate polymers for extrusion of fibres are polyolefins, among others. Preferred polymers for extrusion include polyethylene and polypropylene.

Considerations on the extrusion of fibres with a synergist like PBO and insecticides have been published in International patent application WO2008/098572. Especially the considerations about the design of the extrusion apparatus and about the temperature of the extruder being higher than the temperature throughout the material and the influence of the extrusion time on the active ingredient can be transferred to this invention as well.

The invention is especially directed towards those mosquito strains that are resistant to pyrethroids. As mentioned above, especially the populations of An. gambiae with target site resistance are one of the preferred target insects in connection with the invention due to lack of satisfying PBO-counteraction on the resistance of mosquitoes with the kdr mutation to pyrethroids.

The fibres of the substrate, for example mosquito net or non-woven sheets, may be monofilament yarns or may be multifilament yarns or combinations thereof. A mosquito net may have part of it made by monofilament yarns, for example the roof of the net, and part of it by multifilament yarns, for example the walls of the mosquito net.

An option is to make the roof of a mosquito net of a material, for example polyolefin monofilament yarns, into which the active ingredients PBO+Dinotefuran are incorporated, whereas the side walls of the net are made of another material, for example polyester (polyethylene terephthalate) yarns onto which the active ingredients are provided in a coating by impregnation.

If impregnation is used, a method may optionally be applied as disclosed in International patent application WO 01/37662 and further discussed in WO2008/098572 and WO/2008/122287.

An exemplary embodiment of the process, where fibres are impregnated, is achieved by coating the fibre with a solution or emulsion, for example water emulsion, of an active ingredient, the active ingredient being Dinotefuran, and an accelerator, preferably PBO, or a combination of both. For example, the process comprises the step of

a) preparing a solution or emulsion of the active ingredient and a film forming component reducing wash off and degradation of the active ingredient by forming a water and optionally oil resistant film on the surface of the fibre, for example around the fibre, and applying the solution or emulsion to the fibre, or

b) preparing a first solution or emulsion of the active ingredient and preparing a second solution or emulsion of a film forming component reducing wash off and degradation of the insecticide component from the non living material by forming a water and optionally oil resistant film on the surface of the non living material, for example around the fibres, and applying the solution or water emulsion of the active ingredient on the fibre and then applying the solution or emulsion of the film forming component to the fibre,

wherein said film forming component comprises a polymeric backbone fixative and one or more components selected from paraffin oils or waxes, silicones, silicone oils or waxes, polyfluorocarbons and polyperfluorocarbons or derivatives thereof.

In a further embodiment, the film forming component comprises a mixture of components selected from paraffin oils or waxes, silicones, and silicone oils or waxes, polyfluorocarbon and polyperfluorocarbons or derivatives thereof, preferably a mixture of a polyfluorocarbon and a paraffinic oil or a mixture of a polyfluoroalkyl and a polysiloxan. For example, the silicon oil or wax is a polysiloxan.

In a further embodiment, the polyfluorocarbon, paraffin oil or wax, silicon, silicon oil or wax, or derivatives thereof is/are attached to the polymeric backbone. For example, the polymeric backbone fixative is a resin, polyurethane or polyacryl.

In a preferred embodiment, the film forming component comprises a polymeric backbone fixative polymerizing into a film with polyfluorocarbon side chains on the polymeric backbone in a drying process or in a curing process or in a drying and curing process of the non living material.

The combined solution or emulsion, where the active ingredient is incorporated in the wash resistant agent before application to the fibres, may be used as a composition for impregnation or as part of a composition for impregnation, and it may be mixed with other components. Such components may be other insecticides, synergists, UV protecting agents, preservatives, detergents, fillers, impact modifiers, anti-fogging agents, blowing agents, clarifiers, nucleating agents, coupling agents, conductivity-enhancing agents to prevent static electricity, stabilizers such as anti-oxidants, carbon and oxygen radical scavengers and peroxide decomposing agents and the like, flame retardants, mould release agents, optical brighteners, spreading agents, antiblocking agents, anti-migrating agents, migration promoters, foam-forming agents, anti-soiling agents, anti-fouling agents, thickeners, further biocides, wetting agents, plasticizers adhesive or anti-adhesive agents, fragrance, pigments and dyestuffs and other liquids including water or organic solvents.

It should me emphasized that the use of Dinotefuran and PBO according to the foregoing and following is not limited to these two active ingredients, and a combination of Dinotefuran and another insecticide lies within the scope of the invention. For example, a pyrethroid being efficient against mosquitoes that are non-resistant to pyrethroids may be combined with Dinotefuran, which, is turn, is taking action against resistant mosquitoes. A preferred pyrethroid is Deltamethrin. Also, insecticides other than pyrethroids may be combined with Dinotefuran, including carbamates and organophosphates.

However, due to its efficacy of the combination of Dinotefuran and PBO and in order to avoid cross resistance, other insecticides may be avoided on the substrate—or at least only be present by an amount where the other insecticides in combination on the substrate have a smaller killing efficacy than Dinotefuran.

The method and mosquito nets of the invention is especially useful on those locations, where an Anopheles species have been identified with pyrethroid resistance with the kdr mutation.

The above described method is a selection invention of the more general invention of using PBO to increase the knockdown speed of Dinotefuran on mosquitoes. In the wider sense, the combination of Dinotefuran and PBO may also be used on other substrates, for example on fabrics or tarpaulins, to increase the knockdown speed of Dinotefuran on mosquitoes, especially the uptake speed of Dinotefuran.

A preferred amount of Dinotefuran in connection with a substrate according to the invention, is between 10 and 5000 mg/m², rather 50-750 mg/m², and most preferably, 100-500 mg/m².

A preferred amount of PBO is 5-50 g/kg in term of weight of the substrate, for example a bed net, preferably between 15 and 30 g/kg, for example around 25 g/kg.

In case that Dinotefuran and PBO in combination is further combined with Deltamethrin, (DM) an example of a good combination per kg substrate is
between 20 and 30 g, or more preferably around 25 g PBO,
between 2 and 8 g, or more preferably between 1.8 and 2.8 g, for example around 4 g DM.

For a bedned, for example with 100 denier yarn, good values in units of mg/m² are
for DM between 40 and 320, more preferably between 100 and 200 and most preferably between 140 and 180, for example around 160;
for PBO between 250 and 2000, more preferably between 500 and 1500, and most preferably between 800 and 1200, for example around 1000,
for Dinotefuran between 10 and 5000, preferably between 50 and 750, more preferably between 100 and 500, most preferably between 200 and 400, for example around 300.

For example, for a substrate, preferably a bednet or a non-woven, the following combination in units of mg/m² is one of the preferred embodiments with between 40 and 320 DM, between 250 and 2000 PBO, and between 10 and 5000 Dinotefuran or even more preferably, between 50 and 750 Dinotefuran.

Another example, for a substrate, preferably a bednet or non-woven sheet, the following combination in units of mg/m² is one of the preferred with between 100 and 200 DM, between 500 and 1500 PBO, and between 100 and 500 Dinotefuran.

A further example, for a substrate, preferably a bednet or non-woven sheet, the following combination in units of mg/m² is one of the preferred with between 140 and 180 DM, between 800 and 1200 PBO, and between 200 and 400 Dinotefuran.

In all stated intervals, the end points of the intervals are, optionally included. In other words, the interval of between a first value and a second value may as well include the first and second value.

Another useful combination is 1.8-2.8 g/kg DM, 20-30 g/kg PBO, 300 mg/m² Dinotefuran.

The combination of Dinotefuran and PBO may be used in general to increase the uptake speed of Dinotefuran, for example by providing a non-living material with PBO and Dinotefuran and using it against mosquitoes or other insects, especially, with the aim to increase the uptake of the Dinotefuran or for speeding up the killing effect, especially speeding up the knockdown effect, of Dinotefuran.

For example, a wider application would be a method for killing mosquitoes or other insects with Dinotefuran on a non-living material, comprising
providing the non-living material with Dinotefuran and a further active ingredient on the surface of the non-living material,
providing mosquitoes or other insects on the non-living material for uptake of the Dinotefuran from the non-living material, the Dinotefuran having a knockdown speed on the mosquitoes or the other insects,
increasing the speed of knockdown of mosquitoes or the other insects by Dinotefuran, the increase being due to uptake of the further active ingredient by the mosquitoes or other insects. Preferably the further active ingredient is PBO.

The substrate is, preferably, a bednet, but other applications are useful as well. For example, the substrate may be a tarpaulin. Another example is a wall lining, for example in the form of a net or a fabric. In huts, for example in Africa, such a wall lining may also be used to cover the eave between the top of a wall and the lower edge of the roof.

A preferred embodiment is a nonwoven fabric which is made of thermoplastic polymer yarn into which the active ingredients are incorporated.

A woven or non-woven fabric or net may be made of a combined yarn, where first type of filaments are provided with PBO but without Dinotefuran and second type of filaments are provided with Dinotefuran but without PBO. For a fabric, these two types can be combined through a weaving or knitting process or into a single type of yarn comprising both types of filaments prior to a weaving or knitting process.

Optionally, a third type of filaments may be added to the yarn to form a composite yarn with three types of filaments or may be added otherwise during the production of the product, for example though a weaving or knitting process or during production of a non-woven. Optionally, this third type of filaments comprises a third active ingredient, for example DM, which is incorporated in the material of the third type of filaments or impregnated by a coating on the third type of filaments.

It is also possible to combine one type of filament, into which either Dinotefuran or PBO is incorporated and combine this type of filament with a second type of filament, onto which the other of the above two active ingredients is impregnated by a coating.

Optionally, the two types of filaments may be combined to a single yarn prior to further production, for example knitting or weaving. As a further alternative, the two types of filaments may be combined in a production process for nonwoven materials. Such a combination of two types of filaments may also be used for a nonwoven material.

Optionally, a third type of filaments may be added, the third type having DM incorporated in the material but not PBO or Dinotefuran. The addition may be done prior to any weaving or knitting process or production process for a non-woven product, for example in order to provide a yarn with three types of filaments containing the three active ingredients.

It is also possible to combine a first type of filaments containing Dinotefuran and PBO but not DM with a second type of filaments containing DM but not Dinotefuran nor PBO. Another possibility is to combine filaments with DM and PBO but without Dinotefuran with filaments comprising Dinotefuran but without DM and PBO. The term “comprising” in this case includes the option of incorporation of the active ingredient or ingredients into the filament polymer or the option of impregnating the filament with a coating containing the active ingredient or ingredients.

In order to protect the active ingredients PBO and Dinotefuran against ultraviolet radiation of sunlight, UV protecting agents may be migratably included as well, either incorporated in the material or coated onto the material. The above described varieties of different embodiments, where the active ingredients PBO and Dinotefuran and, optionally, a third active ingredient, for example DM, are combined in different ways may also include UV protection for each of the active ingredients by corresponding agents. One may select one UV protecting agent for protection of all insecticides and synergist, or one may select a UV protecting agent specific for each insecticide and synergist. The UV protecting agent may be provided by incorporation in the material or as part of a coating through an impregnation process. The UV protecting agent is arranged to migrate from inside the material to the surface of the material

Among stabilizers for combination with the synergist and the Dinotefuran, the following is useful, where the content is expressed in weight percent relative to the polymer containing the stabilizer. The stabilizers may be contained by incorporation into the material or in a coating or in both:
a UV absorber from the class of the benzophones, for example 0.1-1% w/w
a UV absorber from the class of the benzotriazoles, from, for example 0.05-0.5% w/w
a hydroperoxide quencher from the class of the organic phosphites, for example 0.5-1.5% w/w
a hydroperoxide quencher from the class of organic thioether, for example 0.01-0.5% w/w
a radical quencher from the class of hindered phenols, hindered amines, benzofuranones, arylamines, aromatic amines, hydroxylamines, for example 0.1-2% w/w
a metal deactivator from the class of organic chelates, for example 0.1-2%
an excited state quencher from the class of nickel chelate, for example 0.05-0.75%
a nano-sized pigment, for example 1-10% w/w or any combination thereof.

The different types of filaments are selected among multifilaments and monofilaments. For example, one type of filaments is a polyolefin monofilament in which an active ingredient is incorporated. Another example is a polyester multifilament coated with a polymer by impregnation, the coating comprising an active ingredient.

### DESCRIPTION OF THE DRAWING

FIG. 1a illustrates a cross section of a substrate with Dinotefuran and PBO, one of these incorporated in a polymer matrix and the other in a coating,

FIG. 1b illustrates the substrate of FIG. 1a after migration of the Dinotefuran and the PBO to the surface of the substrate,

FIG. 2 illustrates a cross section of a substrate with Dinotefuran and PBO incorporated in a polymer matrix,

FIG. 3 illustrates a fibre with a coating,

FIG. 4 illustrates a fibre with a spot-wise coating,

FIG. 5 illustrates a cross section of a fibre with a first, reservoir coating and a second, protecting coating,

FIG. 6 illustrates a mosquito net,

FIG. 7 illustrates a combined yarn.

### DETAILED DESCRIPTION OF THE INVENTION

In the following, the examples for embodiments are given for PBO as the accelerator.

However, is should be read in the sense that PBO may be substituted by another accelerator, in line with the finding of such others accelerators, especially, if such accelerators should turn out to be even more efficient than PBO.

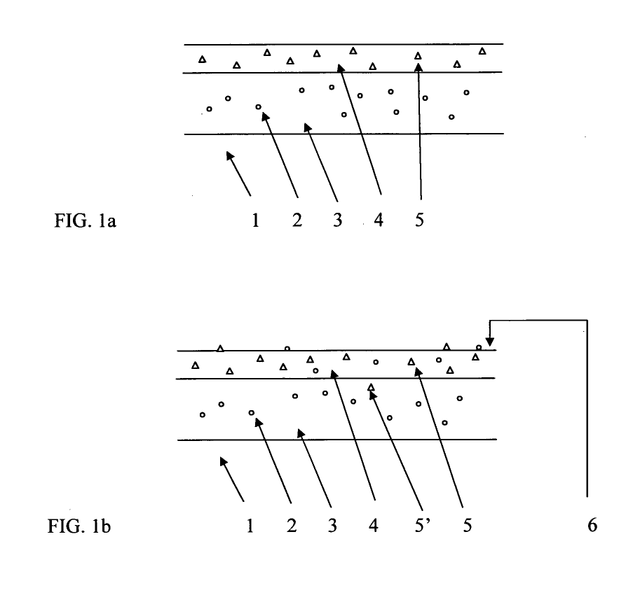

FIG. 1a illustrates a non living object 1 with a first active ingredient is illustrated as circles and a second active ingredient illustrated as triangles. The first and the second active ingredient are PBO and Dinotefuran, respectively, or Dinotefuran and PBO, respectively. As illustrated, the first active ingredient is 2 is incorporated and distributed throughout a polymer matrix 3, typically a thermoplastic polymer matrix. The matrix 3 is coated with a film 4 containing the second active ingredient 5. When the matrix 3 is coated with such film 4, the first ingredient 2 is migrating through the film 4 to the surface 6 of the non living object 1, which is illustrated in FIG. 1b. Also, the second ingredient 5 is migrating to the surface 6, such that the surface 6 contains both active ingredients for uptake by the insect, preferably a mosquito.

In addition, as illustrated in FIG. 1b, if the second active ingredient 5 is capable of migration in the matrix, the second ingredient 5′ may also migrate from the film 4 into the matrix 3. However, the presence of the second ingredient 5′ in the matrix is not given from the onset but may occur only after the coating of the polymer matrix.

The coating is, typically, a polymer itself, for example a coating as disclosed in International patent application WO 01/37662 and further discussed in WO2008/098572 and WO/2008/122287.

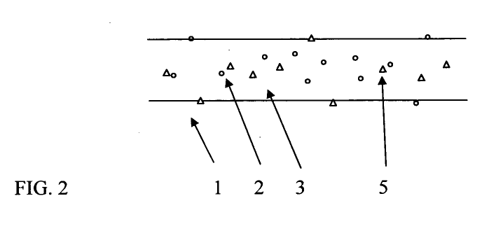

FIG. 2 illustrates a further embodiment, where the two active ingredients are incorporated in a polymer matrix and migrate to the surface of the matrix.

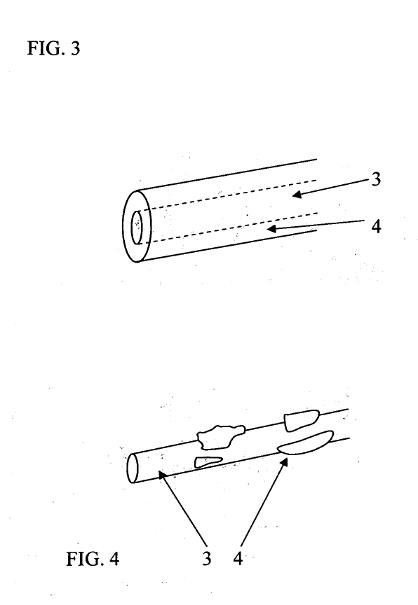

FIG. 3 illustrates a matrix 3 in the form of a fibre coated with a film 4. The drawing only illustrates the principle and is not to scale. The coating 4 of the matrix 3, such as a fibre, may be in the form of a continuous film, as illustrated in FIG. 3, or the coating may be in the form of microscopic fragments, as illustrated in FIG. 4. Such fragments may be in the form of a film, if a film forming component is used. Achieved may such a fragmentary coating be by spraying techniques, for example.

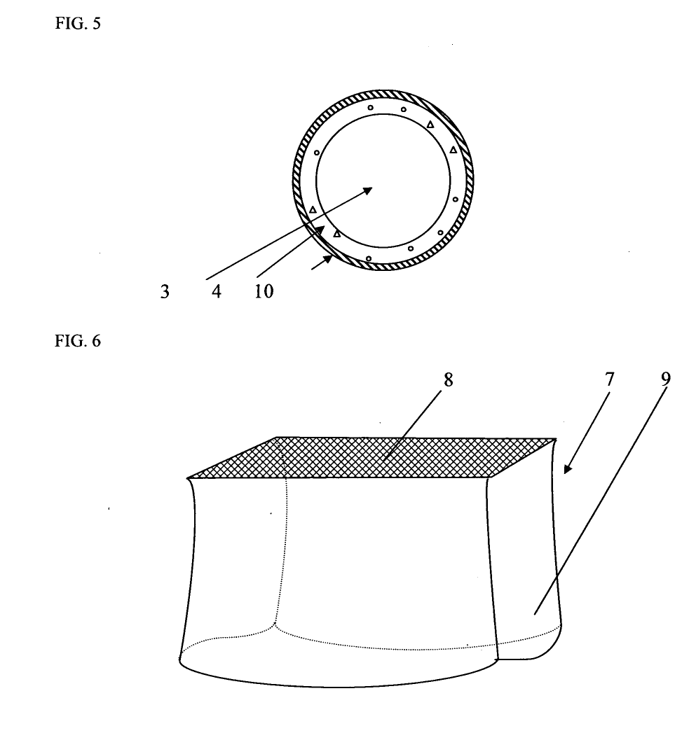

FIG. 5 illustrates a cross section of a fibre containing a core 3 and a first coating 4 containing PBO and Dinotefuran. The first coating 4 is acting like a reservoir of the active ingredients, which are migrating to the surface 6 of the fibres. The reservoir coating 4 is surrounded by a second coating 10, which gives additional protection against wash off and removal of the active ingredients by abrasion but which allows the active ingredients to migrate to the surface of the coated fibre. This second coating 10 may be much thinner than the reservoir coating 4 but efficiently repelling water and oil or other detergents and solvents.

FIG. 6 shows a rectangular shaped mosquito net 7 with a roof 8 and side walls 9. Optionally, the roof 8 may be made in a different material than the side walls 9.

One example of such a combination is the following, where the roof 8 is made of a yarn, into which the active ingredients PBO or Dinotefuran are incorporated, and the sidewalls are made of a yarn, which are coated by impregnation with a film made of a polymer. The film contains PBO and Dinotefuran and polyfluorocarbon for protection of the PBO and the Dinotefuran against solvents. Optionally, the roof may be polyethylene monofilaments and the side walls of polyester multifilaments.

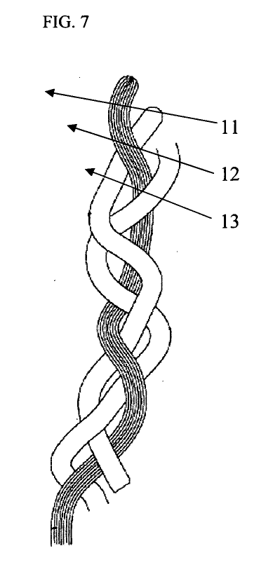

FIG. 7 illustrates a combined yarn made of three filaments 11, 12, 13. The first filament 11 comprises Dinotefuran and no PBO, and the second filament 12 comprises PBO and no Dinotefuran. A third filament 13 is provided in addition with a third active ingredient but does not contain PBO or Dinotefuran. For example, the third active ingredient is Deltamethrin (DM). Such a combined yarn provides three active ingredients but leaves a variety of options for production. For example one or two of the filaments may be made of a material having the active ingredient incorporated, and the third filament may have the third active ingredient incorporated or impregnated as a coating. For each of the three active ingredients, the production can be streamlined according to selected parameters and criteria. Non limiting examples for such parameters and criteria are speed, costs, and usefulness of production processes, and criteria that the active ingredient should deteriorate as little as possible during the production and the product should be lasting active for a long time.

1. A method for killing mosquitoes with Dinotefuran on a polymer substrate, comprising
providing Dinotefuran and PBO on the surface of the substrate,
providing the mosquito on the substrate for uptake of the Dinotefuran, the Dinotefuran having a knockdown speed on the mosquito,
increasing the speed of knockdown of the mosquito by Dinotefuran, the increase being due to uptake of PBO by the mosquito.

2. A method according to claim 1, wherein the increasing of the knockdown speed is achieved by increasing the uptake speed of Dinotefuran due to the simultaneous uptake of PBO by the mosquito.

3. A method according to claim 1, wherein the method comprises the step of identifying in a specific location mosquitoes of a pyrethroid resistant Anopheles species with kdr mutation and providing the substrate in that location.

4. A substrate for a method according to claim 1, the substrate comprising a thermoplastic polymer as a carrier material.

5. A substrate according to claim 4, wherein Dinotefuran and PBO are incorporated into the thermoplastic polymer and distributed throughout the polymer, and wherein the thermoplastic polymer is arranged for migration of the Dinotefuran and the PBO from inside the polymer to the surface of the substrate.

6. A substrate according to claim 4, wherein Dinotefuran is incorporated into the thermoplastic polymer and distributed throughout the polymer, and wherein the thermoplastic polymer is arranged for migration of the incorporated Dinotefuran, and wherein PBO is provided in a coating on the thermoplastic polymer, the coating being arranged for migration of the Dinotefuran and the PBO through the coating to the surface of the coating.

7. A substrate according to claim 4, wherein PBO is incorporated into the thermoplastic polymer and distributed throughout the polymer, and wherein the thermoplastic polymer is arranged for migration of the incorporated PBO, and wherein the Dinotefuran is provided in a coating on the thermoplastic polymer, the coating being arranged for migration of the Dinotefuran and the PBO through the coating to the surface of the coating.

8. A substrate according to claim 4, wherein Dinotefuran and PBO are provided in a coating on the thermoplastic polymer and wherein the coating is arranged for migration of the Dinotefuran and the PBO through the coating to the surface of the coating.

9. A substrate according to claim 8, wherein the coating is used as a reservoir for the PBO and Dinotefuran and is covered by a further coating for protection of the PBO and Dinotefuran against solvents.

10. A substrate according to claim 4, wherein the substrate is a fabric comprising Dinotefuran and PBO on the surface of the fabric.

11. A substrate according to claim 4, the substrate being a mosquito net comprising Dinotefuran and PBO on the surface of the mosquito net.

12. A substrate according to claim 4, the substrate being a tarpaulin comprising Dinotefuran and PBO on the surface of the tarpaulin.

13. A substrate according to claim 4, wherein Dinotefuran is present in an amount of between 10 mg/m² and 5000 mg/m² of the substrate.

14. A substrate according to claim 13, wherein Dinotefuran is present in an amount of between 100 mg/m² and 500 mg/m².

15. A substrate according to claim 4, wherein PBO is present in an amount of 5-50 g/kg in terms of weight of the substrate.

16. A substrate according to claim 4, wherein the substrate comprises a pyrethroid, a carbamate, or an organophosphate.

17. A substrate according to claim 16, wherein the substrate comprises Deltamethrin.

18. A substrate according to claim 17, wherein the content of active ingredients in units of mg/m² of the substrate are for Deltamethrin between 40 and 320, for PBO between 250 and 2000, and for Dinotefuran between 50 and 750.

19-20. (canceled)
